(19) United States
(12) Patent Application Publication
(10) Pub. No.: US 2024/0287843 A1
(43) Pub. Date: Aug. 29, 2024

(54) A Door Operation Support System and Method for Predicting Maintenance

(71) Applicant: Assa Abloy Entrance Systems AB, Landskrona (SE)

(72) Inventor: Holger SIEWERT, Rheda-Wiedenbrueck (DE)

(21) Appl. No.: 18/285,337

(22) PCT Filed: Apr. 5, 2021
(86) PCT No.: PCT/EP2022/058934

§ 371 Date: Oct. 2, 2023

(30) Foreign Application Priority Data
Apr. 6, 2021 (SE) 2130093-4

(51) Int. Cl. E05F 15/71; E05F 15/40; E05F 15/77

(52) U.S. Cl. CPC E05F 15/71; E05F 15/40; E05F 15/77; E05Y 2400/44; E05Y 2400/458

(57) ABSTRACT

The disclosure relates to a door operation support system (100) for predicting maintenance, and timing of maintenance, of a door (1), the door operation support system (100) comprises: a door operation sensor (11a, 11b, 11e, 11d) configured to obtain internal sensor data associated with the operation of the door (I), an environment sensor (12a, 12b, 12c, 12d) configured to obtain external sensor data associated with the environment at the door (I), a processing circuitry (102a, 102b, 102c) configured to obtain first internal sensor data (1isd) indicative of data associated with the operation of the door (1), obtain first external sensor data (1esd) indicative data associated with the environment at the door (1), and determine a first maintenance condition of the door (1) based on the obtained first internal sensor data (1isd) and the obtained first external sensor data (1esd). The disclosure further relates to a method for predicting maintenance and a processing circuitry program product (500).

### TECHNICAL FIELD

The present disclosure relates to a door operation support system for predicting maintenance, a method for predicting maintenance and a processing circuitry program product.

### BACKGROUND ART

In order for a door which is used to open and close an opening in a building or wall to function as expected over time, maintenance of the door is often required. Maintenance is in particular required for industrial doors, that operate under various stressful and demanding circumstances that causes different wear and tear. The maintenance of the door can be crucial for avoiding malfunction of the door, and is important to maintain the door in an operable condition. A non-functioning industrial door can e.g. cause an obstacle in accessing a building or a warehouse, which in turn can cause a delay or hinder in e.g. logistics of goods and have a negative impact on the business. Similar problems can occur for a non-functioning pedestrian door.

When installing a door, the door often gets a certain maintenance condition, that describes what type of maintenance that the door needs, and when in time the maintenance is to be performed. This maintenance condition is often based on a planned usage of the door in a certain assumed environment where the door is installed.

It is quite often that additional maintenance and service of a door is needed and that the maintenance condition needs to be changed from the originally defined maintenance condition. One reason to this is that the door is used in a different way as was initially planned, and that other factors that was not taken into consideration when determining the original maintenance condition affects the required maintenance, such as the environment that the door is in.

Today measures like the number of door cycles, e.g. the number of opening and closing, determines the maintenance condition, e.g. when to replace certain component or when to perform certain service.

### SUMMARY

One problem with that the door is used in a different way as was initially planned, or that other factors that was not taken into consideration when determining the original maintenance condition, is that it is difficult to predict maintenance of the door, e.g. when in time to replace certain component or when to perform certain service. It can also be problematic for a service person to evaluate the current condition of the door. There is a desire to better predict maintenance of a door, in order to e.g. save time and money and in order to maintain a door in an operable condition.

It is an object of the present disclosure to mitigate, alleviate or eliminate one or more of the above-identified deficiencies and disadvantages in the prior art and solve at least the above mentioned problem.

According to a first aspect there is provided a door operation support system for predicting maintenance, and timing of maintenance, of a door. The door operation support system comprises a door operation sensor configured to obtain internal sensor data associated with the operation of the door, and an environment sensor configured to obtain external sensor data associated with the environment at the door. The door operation support system further comprises a processing circuitry configured to be operatively connected to the operation sensor and the environment sensor and configured to obtain first internal sensor data indicative of data associated with the operation of the door, and obtain first external sensor data indicative data associated with the environment at the door, and determine a first maintenance condition of the door based on the obtained first internal sensor data and the obtained first external sensor data.

One advantage with this aspect is that the first maintenance condition is determined based on the combination of obtained internal and external sensor data of the real operation of the door and the real environment that the door is in, that is affecting the required maintenance, which gives a prediction of what type of maintenance that is required and when. The door may be for opening and closing an opening in a building or wall.

According to some embodiments, the processing circuitry is further configured to compare the first internal sensor data with a first predetermined internal sensor data, and compare the first external sensor data with a first predetermined external sensor data.

One advantage with this embodiment is that the predetermined internal and external sensor data can be used as a reference data when determining the first maintenance condition of the door.

According to some embodiments, the processing circuitry is further configured to determine a deviation from a first predetermined maintenance condition based on the first internal sensor data and the first external sensor data.

One advantage with this embodiment is that the first predetermined maintenance condition can be used as a reference when determining the first maintenance condition of the door.

According to some embodiments, determining the deviation from the first predetermined maintenance condition is based on at least a first internal sensor data and at least a first external sensor data obtained over a predefined time period.

One advantage with this embodiment is that the internal sensor data and the external sensor data can be observed over a certain time period in order to determine that there is a deviation from the first predetermined maintenance condition.

According to some embodiments, determining the deviation from the first predetermined maintenance condition is further based on a first internal sensor data and a first external sensor data and at least a second external sensor data.

One advantage with this embodiment is that with the an internal sensor data in view of both a first and a second external sensor data, the deviation can be verified by further external sensor data that refines the determination of the first maintenance condition.

According to some embodiments, determining the deviation from the first predetermined maintenance condition is further based on a predetermined correlation value between the first internal sensor data and the first external sensor data.

One advantage with this embodiment is that based on known correlations between obtained internal and external sensor data, the first maintenance condition can be determined based on the fact that the first internal sensor data and the first external sensor data are linked and both affect the determination of the first maintenance condition.

According to some embodiments, the predetermined maintenance condition and/or the maintenance condition comprises at least any of a life time prediction of a door component, a predicted door component maintenance schedule, a predicted replacement of a door component, and a predicted service action of a door component.

One advantage with this embodiment is that the predetermined maintenance condition and/or the maintenance condition can comprise multiple types of maintenance support information that is useful for keeping the door in an operable state and minimize the cost and time spent on maintaining the door.

According to some embodiments, the processing circuitry is further configured to generate a door maintenance message indicative of a suggested maintenance of the door, and/or generate a door operation message indicative of change in operation of the door.

One advantage with this embodiment is that the door operation support system can provide with instructions that supports managing caretaking of the door in order to prolong the door in an operable state and minimize the cost and time spent on maintaining the door.

According to some embodiments, the door maintenance message and/or door operation message is configured to be received by at least any of a user, via a user interface of an electronic device, or to be received by a machine via an application programming interface of the machine.

One advantage with this embodiment is that both a human and a machine can interact with the door operation support system in order to manage caretaking of the door in order to prolong the door in an operable state and minimize the cost and time spent on maintaining the door.

According to a second aspect there is provided a method for predicting maintenance, and timing of maintenance, of a door. The method comprising obtaining first internal sensor data indicative of data associated with the operation of the door, obtaining first external sensor data indicative of data associated with the environment at the door, and determining a first maintenance condition of the door based on the obtained first internal sensor data and the obtained first external sensor data.

One advantage with this aspect is that the first maintenance condition is determined based on the combination of obtained internal and external sensor data of the real operation of the door and the real environment that the door is in, that is affecting the required maintenance, which gives a prediction of what type of maintenance that is required and when.

According to some embodiments, the method further comprises comparing the first internal sensor data with a first predetermined internal sensor data, and comparing the first external sensor data with a first predetermined external sensor data.

One advantage with this embodiment is that the predetermined internal and external sensor data can be used as a reference data when determining the first maintenance condition of the door.

According to some embodiments, the method further comprises determining a deviation from a first predetermined maintenance condition based on the first internal sensor data and the first external sensor data.

One advantage with this embodiment is that the first predetermined maintenance condition can be used as a reference when determining the first maintenance condition of the door.

According to some embodiments, determining the deviation from the first predetermined maintenance condition is based on at least a first internal sensor data and at least a first external sensor data obtained over a predefined time period.

One advantage with this embodiment is that the internal sensor data and the external sensor data can be observed over a certain time period in order to determine that there is a deviation from the first predetermined maintenance condition.

According to some embodiments, the method further comprises generating a door maintenance message indicative of a suggested maintenance of the door, and/or generating a door operation message indicative of change in operation of the door.

One advantage with this embodiment is that the door operation support system can provide with instructions that supports managing caretaking of the door in order to prolong the door in an operable state and minimize the cost and time spent on maintaining the door.

According to a third aspect there is provided a processing circuitry program product comprising a non-transitory processing circuitry readable medium, having thereon a processing circuitry program comprising program instructions, the processing circuitry program being loadable into a processing circuitry and configured to cause execution of the method according the second aspect when the processing circuitry program is run by the at least one processing circuitry.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIGS. 1a and 1b illustrates a door operation support system according to an embodiment of the present disclosure.

FIG. 2a illustrates first internal sensor data and first predetermined internal sensor data in an example graph according to an embodiment of the present disclosure.

FIG. 2b illustrates first external sensor data and first predetermined external sensor data in an example graph according to an embodiment of the present disclosure.

FIG. 2c illustrates second external sensor data and second predetermined external sensor data in an example graph according to an embodiment of the present disclosure.

FIGS. 3a and 3b illustrates example linkage between predetermined internal sensor data and predetermined external sensor data according to an embodiment of the present disclosure.

FIG. 4a illustrates first internal sensor data indicative of a malfunctioning operation of the door, and first predetermined internal sensor data in an example graph according to an embodiment of the present disclosure.

FIG. 4b illustrates second internal sensor data indicative of a malfunctioning operation of the door, and second predetermined internal sensor data in an example graph according to an embodiment of the present disclosure.

FIG. 5 illustrates a flow chart of the method steps according to the second aspect of the disclosure.

FIG. 6 illustrates a computer program product according to the third aspect of the disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

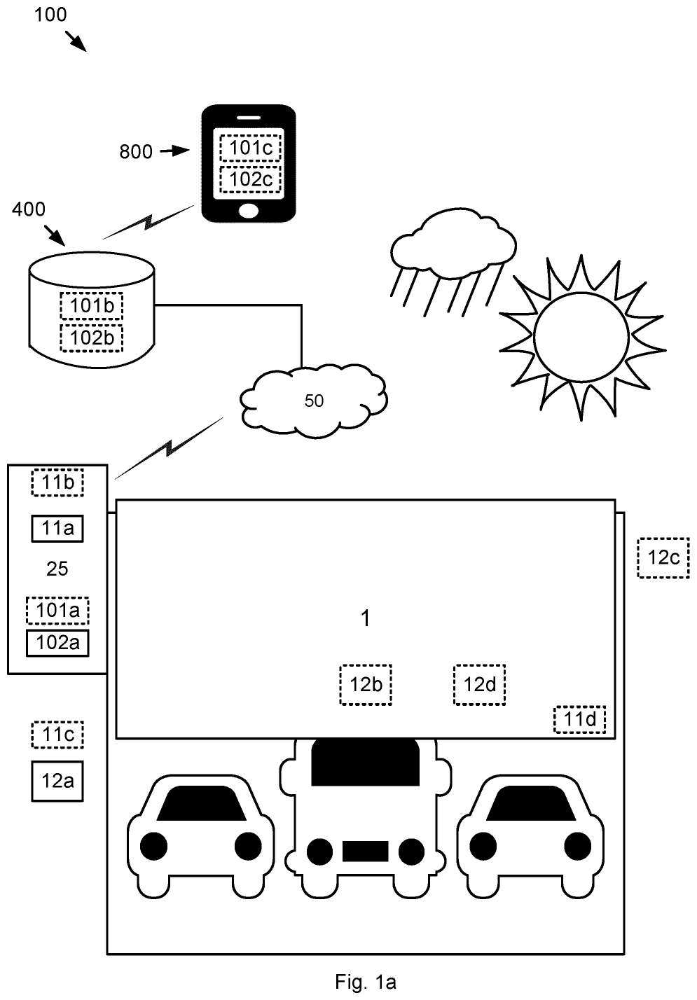

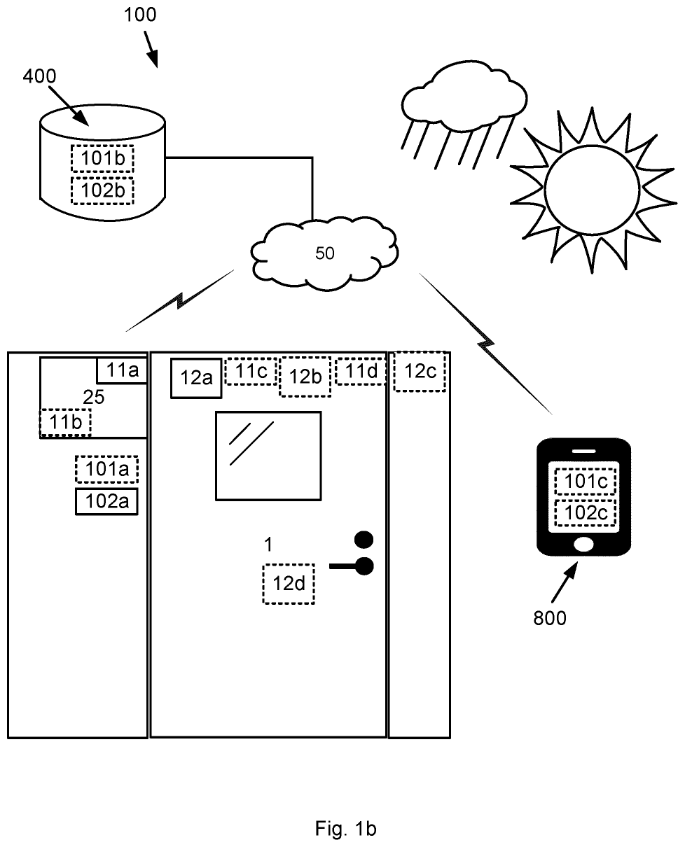

The first aspect of this disclosure shows a door operation support system 100 for predicting maintenance, and timing of maintenance, of a door 1. FIGS. 1a and 1b illustrates a door operation support system 100 according to an embodiment of the present disclosure.

In the example illustration in FIG. 1a, the door 1 is an industrial door, e.g. a door at a logistics center used of loading and offloading goods to and from a warehouse. In the example illustration in FIG. 1b, the door 1 is a pedestrian door, e.g. an entrance door at a building such as a hotel, an office or a home. Generally, the door is used for opening and closing an opening in a building or wall. It is understood that the door operation support system 100 can be configured to predict maintenance, and timing of maintenance, for any type of door. According to some embodiments the door 1 is any of a revolving door, a slider door, a hangar door, a sliding door, a swing door, an overhead sectional door, a folding door, a vertical-lifting door, a high speed door, a garage door and a mega door.

The door operation support system 100 comprises a door operation sensor 11a,11b,11c,11d configured to obtain internal sensor data associated with the operation of the door 1. According to some embodiments the door operation sensor 11a,11b,11c,11d is arranged at the door 1 or at a door operation device 25 used for operation of the door 1. According to some embodiments the door operation sensor 11a,11b,11c,11d is configured to obtain internal sensor data associated with determination of at least any of a torque; a current consumption, an energy consumption, an operating state, an acceleration, a rotation frequency, an opening time, a closing time, a door component temperature, a resistance, a force, a sound, a vibration etc.

Reference is made to the example illustration in FIGS. 1a and 1b. In an example embodiment the door operation sensor 11a is a torque sensor, configured to measure the torque for opening the door 1. In an example embodiment the door operation sensor 11b is an energy consumption sensor, configured to measure the total energy consumption for operating the door 1. In an example embodiment the door operation sensor 11c is an opening state sensor, configured to determine when the door 1 is in an open position. In an example embodiment the door operation sensor 11d is an acceleration sensor, configured to measure the acceleration when closing and/or opening the door 1.

The door operation support system 100 further comprises an environment sensor 12a,12b,12c,12d configured to obtain external sensor data associated with the environment at the door 1. According to some embodiments the environment sensor 12a,12b,12c,12d is arranged at the door 1 or at a door operation device 25 used for operation of the door 1. According to some embodiments the environment sensor 12a,12b,12c,12d is arranged in the vicinity of the door 1. According to some embodiments the environment sensor 12a,12b,12c,12d is configured to obtain external sensor data associated with determination of at least any of an ambient temperature, an atmospheric pressure, humidity, wind speed, solar radiation, air pollution, etc.

Reference is made to the example illustration in FIGS. 1a and 1b. In an example embodiment the environment sensor 12a is a temperature sensor, configured to measure the ambient temperature at the door 1 location. In an example embodiment the environment sensor 12b is an atmospheric pressure sensor, configured to measure the atmospheric pressure at the door 1 location. In an example embodiment the environment sensor 12c is a humidity sensor, configured to measure relative humidity at the door 1 location. In an example embodiment the environment sensor 12d is a wind speed sensor, configured to measure wind speed at the door 1 location.

According to some embodiments the environment sensor 12a,12b,12c,12d is operatively connected to the door operation support system 100 configured to provide external sensor data associated with the environment at the door 1, to the door. In an example embodiment the environment sensor 12a,12b,12c,12d is connected to a weather data server, and configured to provide external sensor data associated with the environment at the door 1, to the door via a communication network 50.

The door operation support system 100 further comprises a processing circuitry 102a,102b,102c configured to be operatively connected to the operation sensor 11a,11b,11c,11d and the environment sensor 12a,12b,12c,12d. According to some embodiments the processing circuitry 102a,102b,102c configured to be operatively connected to the operation sensor 11a,11b,11c,11d and the environment sensor 12a,12b,12c,12d via a communication network 50.

According to some embodiment the processing circuitry 102a is comprised in the door operation device 25 arranged at the door. According to some embodiment the processing circuitry 102b is comprised in a server 400 operatively connected to the door operation support system 100 via a communication network 50. According to some embodiment the processing circuitry 102c is comprised in a portable electronic device 800 operatively connected to the door operation support system 100 via a communication network 50.

According to some embodiments the communication network 50 is a wireless communication network. According to some embodiments the wireless communication network is a standardized wireless local area network such as a Wireless Local Area Network, WLAN, Bluetooth™, ZigBee, Ultra-Wideband, UWB, Radio Frequency Identification, RFID, or similar network. According to some embodiments the wireless communication network is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network. According to some embodiments the wireless communication network can also be a combination of both a wireless local area network and a wireless wide area network. According to some embodiments communication network 50 can be a combination a wired communication network and a wireless communication network. According to some embodiments the communication network 50 is defined by common Internet Protocols.

The processing circuitry 102a,102b,102c of the door operation support system 100 is configured to obtain first internal sensor data 1isd indicative of data associated with the operation of the door 1, obtain first external sensor data 1esd indicative data associated with the environment at the door 1, and determine a first maintenance condition of the door 1 based on the obtained first internal sensor data 1isd and the obtained first external sensor data 1esd.

One advantage with this aspect is that the first maintenance condition is determined based on the combination of obtained internal and external sensor data of the real operation of the door and the real environment that the door is in, that is affecting the required maintenance, which gives a prediction of what type of maintenance that is required and when.

According to some embodiments the obtained first internal sensor data 1isd and the first external sensor data 1esd are combined and used together as input for determining the real operation and the environment that the door 1 is in and determining the first maintenance condition of the door 1 based on knowledge of how the first internal sensor data 1isd and the first external sensor data 1esd affects the condition of the door 1.

According to some embodiments the obtained first internal sensor data 1isd and the first external sensor data 1esd are linked and together affect the first maintenance condition. In an example both the obtained first internal sensor data 1isd and the first external sensor data 1esd affects the condition of a certain door component.

According to some embodiments the first maintenance condition of the door 1 replaces any previous existing maintenance condition of the door 1. According to some embodiments the first internal sensor data 1isd and the first external sensor data 1esd are obtained continuously and the determination of the first maintenance condition of the door 1 based on the obtained first internal sensor data 1isd and the obtained first external sensor data 1esd is determined continuously. In an example the first maintenance condition of the door 1 is determined recurrent according to a predefined interval.

According to some embodiments the processing circuitry 102a,102b,102c is further configured to compare the first internal sensor data 1isd with a first predetermined internal sensor data 1p-isd, and compare the first external sensor data 1esd with a first predetermined external sensor data 1p-esd.

One advantage with this embodiment is that the predetermined internal and external sensor data can be used as a reference data when determining the first maintenance condition of the door.

According to some embodiments, in a determination that the comparison of the first internal sensor data 1isd when compared with the first predetermined internal sensor data 1p-isd, results in a difference that is outside of a predetermined threshold value, causes the determination of the first maintenance condition of the door 1.

According to some embodiments, in a determination that the comparison of the first external sensor data 1esd when compared with the first predetermined external sensor data 1p-esd, results in a difference that is outside of a predetermined threshold value, causes the determination of the first maintenance condition of the door 1.

The door operation support system 100 further comprises a memory 101a,101b,101c configured to be operatively connected to the processing circuitry 102a,102b,102c. According to some embodiments the memory 101a,101b,101c is configured to be operatively connected to the processing circuitry 102a,102b,102c via a communication network 50.

According to some embodiment the processing memory 101a is comprised in the door operation device 25 arranged at the door. According to some embodiment the memory 101b is comprised in a server 400 operatively connected to the door operation support system 100 via a communication network 50. According to some embodiment the memory 101c is comprised in a portable electronic device 800 operatively connected to the door operation support system 100 via a communication network 50.

According to some embodiment the first predetermined internal sensor data 1p-isd and the first predetermined external sensor data 1p-esd is stored in the memory 101a,101b,101c. According some embodiments the processing circuitry 102a,102b,102c is configured to obtain the first predetermined internal sensor data 1p-isd and the first predetermined external sensor data 1p-esd from the memory 101a,101b,101c.

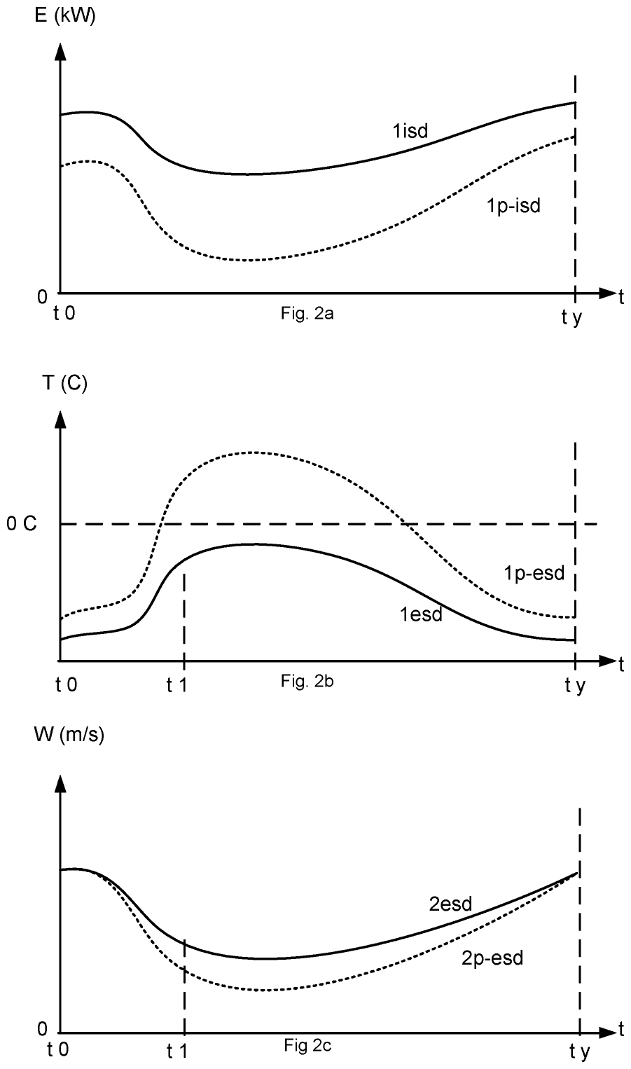

FIG. 2a illustrates first internal sensor data 1isd and first predetermined internal sensor data 1p-isd in an example graph according to an embodiment of the present disclosure. In an example embodiment the door operation sensor 11b is an energy consumption sensor, configured to measure the total energy consumption for operating the door 1. In the example illustrative graph in FIG. 2a the first internal sensor data 1isd is the total energy consumption, E, in kilowatts, kW, over time. In the example graph the obtained first internal sensor data 1isd indicates a higher energy consumption over time compared to the first predetermined internal sensor data 1p-isd.

FIG. 2b illustrates first external sensor data 1esd and first predetermined external sensor data 1p-esd in an example graph according to an embodiment of the present disclosure. In an example embodiment the environment sensor 12a is a temperature sensor, configured to measure the ambient temperature at the door 1 location. In the example illustrative graph in FIG. 2b the first external sensor data 1esd is the temperature, T, in Celsius degrees, C, at the door 1 location over time. In the example graph the obtained first external sensor data 1esd indicates a lower ambient temperature over time compared to the first predetermined external sensor data 1p-esd.

FIG. 2c illustrates second external sensor data 2esd and second predetermined external sensor data 2p-esd in an example graph according to an embodiment of the present disclosure. In an example embodiment the environment sensor 12d is a wind speed sensor, configured to measure wind speed at the door 1 location over time. In the example illustrative graph in FIG. 2C the second external sensor data 2esd is the wind speed, W, in meters per second, m/s, at the door 1 location over time. In the example graph the obtained second external sensor data 2esd indicates a higher wind speed most of the time compared to the second predetermined external sensor data 2p-esd.

According to some embodiments the processing circuitry 102a,102b,102c is further configured to determine a deviation from a first predetermined maintenance condition based on the first internal sensor data 1isd and the first external sensor data 1esd.

One advantage with this embodiment is that the first predetermined maintenance condition can be used as a reference when determining the first maintenance condition of the door.

According to some embodiments the first predetermined maintenance condition is based on at least first predetermined internal sensor data 1p-isd and a first predetermined external sensor data 1p-esd. In an example, when installing the door 1, the first predetermined internal sensor data 1p-isd and a first predetermined external sensor data 1p-esd are defined based on expected usage and expected environment of the door 1. According to some embodiments the first predetermined maintenance condition defines the maintenance for a door component and determined based on the first predetermined internal sensor data 1p-isd and a first predetermined external sensor data 1p-esd. In an example the maintenance of a motor for operating the opening and closing of the door 1 is determined based on the total energy consumption for operating the door 1, and the ambient temperature at the door 1 over a certain time period. In the example the first predetermined maintenance condition defines service of the motor one time per year. By determining a deviation from the first predetermined maintenance condition based on the first internal sensor data 1isd and the first external sensor data 1esd, e.g. based on a higher consumed energy for operating the door 1 and operating the door 1 at lower temperature as predicted, the first maintenance condition of the door can be determined. In the example the first maintenance condition defines service of the motor to be two times per year instead of one time per year as defined by the first predetermined maintenance condition.

According to some embodiments determining the deviation from the first predetermined maintenance condition is based on at least a first internal sensor data 1isd,2isd, . . . ,nisd and at least a first external sensor data 1esd,2esd, . . . nesd obtained over a predefined time period.

One advantage with this embodiment is that the internal sensor data and the external sensor data can be observed over a certain time period in order to determine that there is a deviation from the first predetermined maintenance condition.

In an example a higher consumed energy for operating the door 1 and operating the door 1 a lower temperature as predicted over time, both affects the first maintenance condition.

In an example both the first internal sensor data 1isd and the first external sensor data 1esd are linked in that at lower temperatures the motor operates at a higher torque for opening the door, which consumes more energy, and also that the number of times the door 1 open and close, also affects the consumed energy, the wear and tear of the motor is affected, which results in a first maintenance condition that is different compare to the first predetermined maintenance condition.

According to some embodiments determining the deviation from the first predetermined maintenance condition is further based on a first internal sensor data 1isd and a first external sensor data 1esd and at least a second external sensor data 2esd, . . . ,needs.

In a further example, the energy consumption for operating the door 1 is further affected by the wind speed at the door location. Operating the door 1 in an environment with higher wind speed as predicted, and at lower temperatures as predicted, and also with a more frequent opening and closing frequency as predicted, all together affects the consumed energy, and the wear and tear of the motor is affected, which results in a first maintenance condition that is different compare to the first predetermined maintenance condition.

One advantage with this embodiment is that based on the internal sensor data in view of both a first and a second external sensor data, the deviation can be verified by further external sensor data that refines the determination of the first maintenance condition.

According to some embodiments determining the deviation from the first predetermined maintenance condition is further based on a predetermined correlation value between the first internal sensor data 1isd and the first external sensor data 1esd.

One advantage with this embodiment is that based on known correlations between obtained internal and external sensor data the first maintenance condition can be determined based on the fact that the first internal sensor data 1isd and the first external sensor data 1esd are linked and both affect the determination of the first maintenance condition.

According to some embodiments, the predetermined correlation value between internal sensor data and external sensor data can be used to determine malfunction in the operation of the door, by using the predetermined correlation value to identify a certain internal sensor data that stands out from a certain predetermined internal sensor data.

According to some embodiments the predetermined correlation value between the first internal sensor data 1isd and the first external sensor data 1esd is defined by a correlation value between −1 and 1. In an example the correlation value, p, can be described by −1<p<1. In the example a value p=0 indicates no correlation, a value p=−1 indicates a maximal negative relation and a value p=1 indicates a maximal positive relation. According to some embodiments the higher correlation value the higher linkage between the first internal sensor data 1isd and the first external sensor data 1esd.

In an example, the first internal sensor data 1isd is the total energy consumption, E, in kilowatts, kW, over time, and the first external sensor data 1esd is the ambient temperature, T, in Celsius degrees, C, at the door 1 location over time, the correlation value between the first internal sensor data 1isd and the first external sensor data 1esd is 0.8.

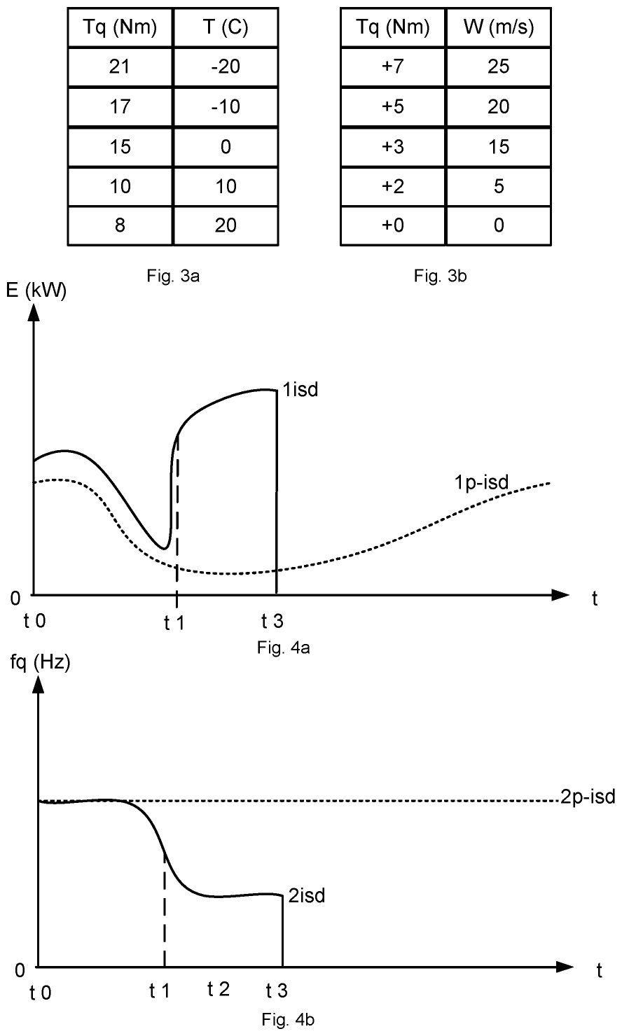

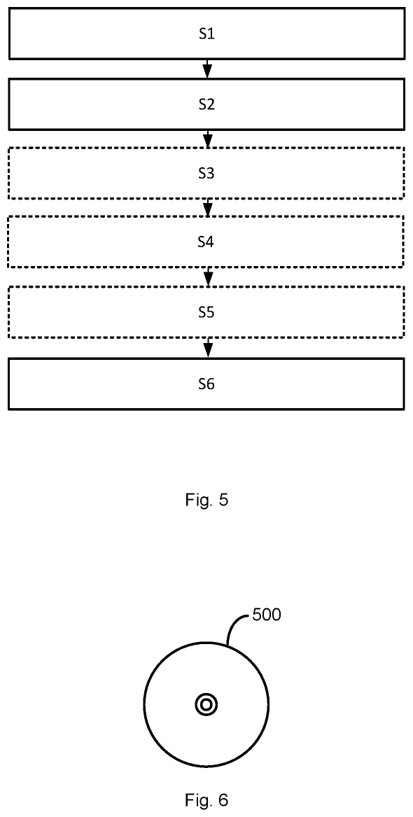

FIGS. 3a and 3b illustrates example linkage between predetermined internal sensor data and predetermined external sensor data according to an embodiment of the present disclosure. According to some embodiments the correlation between different internal sensor data and different external sensor data is predetermined and established by statistic measurements over time.

In the example illustration in FIG. 3a the fact that the motor for operating the opening and closing of the door 1 requires more toque, Tq, in Newton meters, Nm, to open the door 1 when the ambient temperature is below zero degrees Celsius, compare to when the ambient temperature is above zero degrees Celsius, is correlated with the fact that the total energy consumption, E, in kilowatts, kW, increases when the ambient temperature is below zero degrees Celsius, compare to then the ambient temperature is above zero degrees Celsius. In the example, the cause for the requirement of more torque can be that the friction in rubber, bearings, rails etc. may be higher at lower temperatures.

In the example illustration in FIG. 3b the fact that the motor for operating the opening and closing of the door 1 requires more toque, Tq to open the door 1 when the wind speed, W, in meters per second, m/s, is higher, compare to when the wind speed is lower is correlated with the fact that the total energy consumption, E, in kilowatts, kW, increases when the wind speed is higher, compare to then the wind speed is lower. In the example, the cause for the requirement of more torque can be that the wind causes the door 1 to move and cause a higher friction in rubber, bearings, rails etc.

It is understood that the above examples are just for illustration, and that there are multiple other internal and external sensor data that can be linked by a predetermined correlation value.

According to some embodiments the predetermined maintenance condition and/or the maintenance condition comprises at least any of a life time prediction of a door component, a predicted door component maintenance schedule, a predicted replacement of a door component, and a predicted service action of a door component.

One advantage with this embodiment is that the predetermined maintenance condition and/or the maintenance condition can comprise multiple types of maintenance support information that is useful for keeping the door in an operable state and minimize the cost and time spent on maintaining the door.

In an example the life time prediction of a door component is determined based on 1S both internal and external sensor data. In an example the life time of the motor for operating the opening and closing of the door 1 is both dependent on the number of times the door 1 is opened and closed, but also dependent on the ambient temperature. The fact that the opening and closing of the door 1 in a clod ambient temperature requires more torque than opening and closing of the door 1 in a warm ambient temperature, has the impact the motor is worn out faster in a climate when the door 1 is in an environment with a clod ambient temperature, which impacts the life time of the motor and hence the first maintenance condition of the door 1. On the contrary, it can also be determined that the motor gets a prolonged lifetime in a determination that the ambient temperature is higher than initially predicted, which impacts the life time of the motor and hence the first maintenance condition of the door 1.

A predicted door component maintenance schedule can be affected accordingly, for example maintenance of a motor, e.g. lubrications of bearings in the motor may be required more frequent than predicted, in the case it turns out that the door 1 is opened and closed more than initially predicted in combination with that the motor is required to run with more torque over time than was initially predicted.

According to some embodiments the processing circuitry 102a,102b,102c is further configured to generate a door maintenance message indicative of a suggested maintenance of the door 1, and/or generate a door operation message indicative of change in operation of the door 1.

One advantage with this embodiment is that the door operation support system 100 can provide with instructions that supports managing caretaking of the door 1 in order to prolong the door 1 in an operable state and minimize the cost and time spent on maintaining the door.

According to some embodiments at least any of the door maintenance message and the door operation message is based on the determined first maintenance condition of the door 1.

According to some embodiments the door maintenance message and/or door operation message is configured to be received by at least any of a user, via a user interface of an electronic device, or to be received by a machine via an application programming interface of the machine.

One advantage with this embodiment is that both a human and a machine can interact with the door operation support system 100 in order to manage caretaking of the door 1 in order to prolong the door 1 in an operable state and minimize the cost and time spent on maintaining the door1.

According to some embodiments at least any of the door maintenance message and the door operation message is generated dependent on a certain change in the first maintenance condition of the door 1, compare to a predetermined maintenance condition of the door 1. According to some embodiments at least any of the door maintenance message and the door operation message is generated if the certain change is above a certain threshold value compared to the determined first maintenance condition of the door 1.

According to some embodiments at least any of the door maintenance message and the door operation message is generated dependent that the derivate of the change is above a certain threshold value compared to the derivate of change in relation to the determined first maintenance condition of the door 1. According to some embodiments the derivate of the change is used for determining when in time certain maintenance is required.

In an example, if an internal sensor data is changed dramatically, this can be an indication of a relatively urgent need for maintenance, while if an internal sensor data is changed at a slow pace this can be an indication of a relatively slow need for maintenance. FIG. 4a illustrates first internal sensor data 1isd indicative of a malfunctioning operation of the door 1, and first predetermined internal sensor data 1p-isd in an example graph according to an embodiment of the present disclosure. In the example illustration the first internal sensor data 1isd is the total energy consumption, E, in kilowatts, kW, over time.

In the FIG. 4a at time t1, the first internal sensor data 1isd indicates a dramatically, representing a dramatical increase in the total energy consumption. In the example a door maintenance message is generated based in the dramatically increase in the total energy consumption.

According to some embodiments the door maintenance message and/or door operation message comprising multiple internal and external sensor data and configured to be received by at least any of a user, via a user interface of an electronic device, or to be received by a machine via an application programming interface of the machine.

According to some embodiments the determination of the first maintenance condition of the door 1 is based on the obtained multiple internal sensor data 1isd, 2isd, . . . nesd and obtained multiple external sensor data 1esd, 2esd, . . . ,nesd.

According to some embodiments based on the obtained multiple internal sensor data and the obtained multiple external sensor data, and based on multiple predetermined correlation values between the multiple internal sensor data and the multiple external sensor data, the first maintenance condition of the door 1 is determined.

According to some embodiments the processing circuitry 102a,102b,102c is further configured to identify a first internal sensor data 1isd indicative of a malfunctioning operation of the door 1 by comparing obtained multiple internal sensor data and obtained multiple external sensor data.

In the following two use cases, two examples will be given for describing the door operation support system 100.

In the first use case reference is made to the example graphs of FIGS. 2a-2b. In FIG. 2a a first internal sensor data 1isd indicative of data associated with the operation of the door 1 is obtained. In the example illustration the first internal sensor data 1isd is the total energy consumption, E, in kilowatts, kW, over time. In the example the first internal sensor data 1isd is obtained over a time period of one year, time t0 to ty. In the example illustration the first internal sensor data 1isd is compared with a first predetermined internal sensor data 1p-isd. In FIG. 2b first external sensor data 1esd indicative data associated with the environment at the door 1 is obtained. In the example illustration first external sensor data 1esd is the ambient temperature at the door location over time. In the example first external sensor data 1esd is obtained over a time period of one year, time t0 to ty. In the example illustration the first external sensor data 1esd is compared with first predetermined external sensor data 1p-esd. In the example, the door 1 is operated in a lower temperature than initially predicted and a first maintenance condition of the door 1 is determined based on the obtained first internal sensor data 1isd and the obtained first external sensor data 1esd. In the example, due to the operation of the door 1 at lower temperatures than initially predicted, the maintenance condition comprises at least any change in e.g. the life time prediction of a door component, a change in a predicted door component maintenance schedule, a change in a predicted replacement of a door component, and a change in a predicted service action of a door component. In the example illustration of FIG. 2b the ambient temperature is always below zero degrees Celsius compare to the predicted ambient temperature to be at least below zero degrees Celsius half of the year, which can cause a first maintenance condition of the door 1 that recommends replacing a door component at an earlier point in time compare to a previous maintenance condition.

For the second use case reference is made the example graph of FIG. 4a. At the time t1 in FIG. 4a, the first internal sensor data 1isd indicates a dramatically, representing a dramatical increase in the total energy consumption. With reference to FIG. 2b at the same time, t1, it can be determined that the ambient temperature is lower than the predetermined temperature. According to the predetermined internal sensor data as illustrated in FIG. 3a a lower ambient temperature leads to an increase in total energy consumption since the required torque is increased. Further, with reference to FIG. 2c at the same time, t1, it can be determined that the wind speed is higher than the predetermined temperature. According to the predetermined internal sensor data as illustrated in FIG. 3b a higher wind speed leads to an increase in total energy consumption since the required torque is increased. However, it can be determined that at the time to, both the ambient temperature was lower, and the wind speed was higher but with reference to FIG. 4a, the total energy consumption was lower at time t0 compare to t1, which indicates that something is wrong. This determination can only be concluded thanks to the obtained internal and external sensor data. The conclusion is further supported by correlation values. Hence it can be determined that the ambient temperature and the wind speed are likely not the cause of the dramatical increase in the total energy consumption.

FIG. 4b illustrates second internal sensor data 2isd and second predetermined internal sensor data 2p-isd in an example graph according to an embodiment of the present disclosure. The second internal sensor data 2isd in the example refers to an operation frequency, fq, in Hertz, Hz, of the motor. In the example the second predetermined internal sensor data 2p-isd indicates an expected operation frequency that is stable. At time t1, the operation frequency dips. It seems that the dip in the motor operation frequency causes the dramatical increase in the total energy consumption. In the example the door operation support system 100 generates both a door maintenance message and a door operation message. In the example the door maintenance message comprises a suggests a replacement of the motor at a time t2, as illustrated in FIG. 4b. In the example the door operation message comprising instructions to start running the door motor at an operation frequency that is half of the normal operation frequency. In the example the door operation message further comprising instructions to stop running the door motor at time t3 if maintenance has not occurred at time t2, in order to avoid a more severe damage to the door 1 e.g. due to an unplanned stop of the motor.

According to some embodiments the door maintenance message and/or the door operation message is received by a user, via a user interface of an electronic device 800 via a communications network 50 as illustrated in FIGS. 1a and 1b. In an example the user of the electronic device 800 can retrieve multiple internal and external sensor data to the electronic device 800 and control operation of the door 1 via the user interface of the electronic device 800 and carry out instructions according to the first maintenance condition of the door.

According to some embodiments the door maintenance message and/or the door operation message is received by a machine via an application programming interface of the machine. In an example the machine is a server 400, e.g. a door maintenance service server. In an example a user of the server 400 and/or the server 400 itself, can retrieve multiple internal and external sensor data to the electronic server 400 and control operation of the door 1 via a user interface of the server 400 and/or a communications network 50 and carry out instructions according to the first maintenance condition of the door.

In a further example the reason for the dip in the motor operation frequency that causes the dramatical increase in the total energy consumption, can be further determined based on e.g. further internal sensor data such as accelerometer data to e.g. determine if the door 1 has been hit by a truck etc.

The second aspect of this disclosure shows a method for predicting maintenance, and timing of maintenance, of a door 1, the method comprising the step of S1 obtaining first internal sensor data 1isd indicative of data associated with the operation of the door 1, the step of S2 obtaining first external sensor data 1esd indicative of data associated with the environment at the door 1, and the step of S6 determining first maintenance condition of the door 1 based on the obtained first internal sensor data 1isd and the obtained first external sensor data 1esd.

One advantage with this aspect is that the first maintenance condition is determined based on the combination of obtained internal and external sensor data of the real operation of the door and the real environment that the door is in, that is affecting the required maintenance, which gives a prediction of what type of maintenance that is required and when.

According to some embodiments the method further comprises the step of S3 comparing the first internal sensor data 1isd with a first predetermined internal sensor data 1p-isd, and the step of S4 comparing the first external sensor data 1esd with a first predetermined external sensor data 1p-esd.

One advantage with this embodiment is that the predetermined internal and external sensor data can be used as a reference data when determining the first maintenance condition of the door.

According to some embodiments the method further comprises the step of S5 determining a deviation from a first predetermined maintenance condition based on the first internal sensor data 1isd and the first external sensor data 1esd.

One advantage with this embodiment is that the first predetermined maintenance condition can be used as a reference when determining the first maintenance condition of the door.

According to some embodiments determining the deviation from the first predetermined maintenance condition is based on at least a first internal sensor data 1isd,2isd, . . . ,nisd and at least a first external sensor data 1esd,2esd, . . . nesd obtained over a predefined time period.

One advantage with this embodiment is that the internal sensor data and the external sensor data can be observed over a certain time period in order to determine that there is a deviation from the first predetermined maintenance condition.

According to some embodiments the method further comprises the step of S7 generating a door maintenance message indicative of a suggested maintenance of the door 1 and/or the step of S8 generating a door operation message indicative of change in operation of the door 1.

One advantage with this embodiment is that the door operation support system 100 can provide with instructions that supports managing caretaking of the door 1 in order to prolong the door 1 in an operable state and minimize the cost and time spent on maintaining the door 1.

The third aspect of this disclosure shows a processing circuitry program product comprising a non-transitory processing circuitry readable medium, having thereon a processing circuitry program comprising program instructions, the processing circuitry program being loadable into a processing circuitry 102a,102b,102c and configured to cause execution of the method the second aspect when the processing circuitry program is run by the at least one processing circuitry 102a,102b,102c.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A door operation support system (100) for predicting maintenance, and timing of maintenance, of a door (1), the door operation support system (100) comprises:
a door operation sensor (11a, 11b, 11c, 11d) configured to obtain internal sensor data associated with the operation of the door (1);
an environment sensor (12a, 12b, 12c, 12d) configured to obtain external sensor data associated with the environment at the door (1); and
a processing circuitry (102a, 102b, 102c) configured to be operatively connected to the operation sensor (11a, 11b, 11c, 11d) and the environment sensor (12a, 12b, 12c, 12d) and configured to:
obtain first internal sensor data (1isd) indicative of data associated with the operation of the door (1);
obtain first external sensor data (1esd) indicative data associated with the environment at the door (1); and
determine a first maintenance condition of the door (1) based on the obtained first internal sensor data (1isd) and the obtained first external sensor data (1esd).

2. The door operation support system (100) according to claim 1, wherein the processing circuitry (102a, 102b, 102c) is further configured to:
compare the first internal sensor data (1isd) with a first predetermined internal sensor data (1p-isd); and
compare the first external sensor data (1esd) with a first predetermined external sensor data (1p-esd).

3. The door operation support system (100) according to claim 1, wherein the processing circuitry (102a, 102b, 102c) is further configured to:
determine a deviation from a first predetermined maintenance condition based on the first internal sensor data (1isd) and the first external sensor data (1esd).

4. The door operation support system (100) according to claim 3, wherein determining the deviation from the first predetermined maintenance condition is based on at least the first internal sensor data (1isd,2isd, . . . ,nisd) and at least the first external sensor data (1esd,2esd, . . . nesd) obtained over a predefined time period.

5. The door operation support system (100) according to claim 4, wherein determining the deviation from the first predetermined maintenance condition is further based on the first internal sensor data (1isd) and the first external sensor data (1esd) and at least a second external sensor data (2esd, . . . ,nesd).

6. The door operation support system (100) according to claim 4, wherein determining the deviation from the first predetermined maintenance condition is further based on a predetermined correlation value between the first internal sensor data (1isd) and the first external sensor data (1esd).

7. The door operation support system (100) according to claim 3, wherein the first predetermined maintenance condition and/or the first maintenance condition comprises at least any of a life time prediction of a door component; a predicted door component maintenance schedule; a predicted replacement of a door component; and a predicted service action of a door component.

8. The door operation support system (100) according to claim 1, wherein the processing circuitry (102a, 102b, 102c) is further configured to:
generate a door maintenance message indicative of a suggested maintenance of the door (1); and/or -generate a door operation message indicative of change in operation of the door (1).

9. The door operation support system (100) according to claim 8, wherein the door maintenance message and/or door operation message is configured to be received by at least any of a user, via a user interface of an electronic device, or to be received by a machine via an application programming interface of the machine.

10. A method for predicting maintenance, and timing of maintenance, of a door (1), the method comprising:
(SI) obtaining first internal sensor data (1isd) indicative of data associated with the operation of the door (1);
(S2) obtaining first external sensor data (1esd) indicative of data associated with the environment at the door (1); and
(S6) determining a first maintenance condition of the door (1) based on the obtained first internal sensor data (1isd) and the obtained first external sensor data (1esd).

11. The method according to claim 10 further comprising:
(SB) comparing the first internal sensor data (1isd) with a first predetermined internal sensor data (1p-isd); and
(S4) comparing the first external sensor data (1esd) with a first predetermined external sensor data (1p-esd).

12. The method according to claim 10 further comprising:
(S5) determining a deviation from a first predetermined maintenance condition based on the first internal sensor data (1isd) and the first external sensor data (1esd).

13. The method according to claim 12, wherein determining the deviation from the first predetermined maintenance condition is based on at least the first internal sensor data (1isd,2isd, . . . ,nisd) and at least the first external sensor data (1esd,2esd, . . . nesd) obtained over a predefined time period.

14. The method according to claim 10 further comprising:
(S7) generating a door maintenance message indicative of a suggested maintenance of the door (1); and/or
(S8) generating a door operation message indicative of change in operation of the door (1).

15. A processing circuitry program product (500) comprising a non-transitory processing circuitry readable medium, having thereon a processing circuitry program comprising program instructions, the processing circuitry program being loadable into a processing circuitry (102a, 102b, 102c) and configured to cause execution of the method according to claim 10 when the processing circuitry program is run by the at least one processing circuitry (102a, 102b, 102c).

16. A method for predicting maintenance, and timing of maintenance, of a door, the method comprising:
providing a door operating support system according to claim 1;
obtaining the first internal sensor data indicative of data associated with the operation of the door;
obtaining the first external sensor data indicative of data associated with the environment at the door; and
determining the first maintenance condition of the door based on the obtained first internal sensor data) and the obtained first external sensor data.
